(19) United States
(12) Patent Application Publication
(10) Pub. No.: US 2004/0050345 A1
(43) Pub. Date: Mar. 18, 2004

(54) Fuel reformer control system and method

(76) Inventor: Shawn D. Bauer, Indianapolis, IN (US)

Correspondence Address: BARNES & THORNBURG, 11 SOUTH MERIDIAN, INDIANAPOLIS, IN, 46204

(21) Appl. No.: 10/245,268

(22) Filed: Sep. 17, 2002

(51) Int. Cl. F02B 43/08

(52) U.S. Cl. 123/3

(57) ABSTRACT

An integrated electronic control unit is configured to execute a routine for controlling operation of the internal combustion engine, along with a routine for controlling operation of the fuel reformer. In one specific implementation, the electronic control unit is embodied as an engine control unit of a vehicle or a stationary power generator. A method of controlling an engine and a fuel reformer is also disclosed

### FIELD OF THE DISCLOSURE

The present disclosure relates to generally to a control system, and more particularly to a control system for a fuel reformer.

### BACKGROUND OF THE DISCLOSURE

Fuel reformers reform hydrocarbon fuel into a reformate gas such as hydrogen-rich gas. Such reformate gas may be utilized as fuel or fuel additive in the operation of an internal combustion engine. Such reformate gas may also be utilized to regenerate an emission abatement device or as a fuel for a fuel cell.

### SUMMARY OF THE DISCLOSURE

According to one aspect of the present disclosure, there is provided an electronic control unit for controlling operation of both an internal combustion engine and a fuel reformer.

In one specific implementation, the electronic control unit is embodied as an engine control unit of a vehicle or a stationary power generator. As such, the engine control unit executes a routine for controlling operation of the internal combustion engine, along with a routine for controlling operation of the fuel reformer. Such routines may be embodied as separate software routines, or may be combined as a single software routine.

In accordance with another aspect of the present disclosure, there is provided a method for operating a power system having an internal combustion engine and a fuel reformer by use of the same control unit.

In one specific implementation of this method, the control unit is the engine control unit of a vehicle or stationary power generator.

### BRIEF DESCRIPTION OF THE DRAWINGS

FIG. 1 is a simplified block diagram of a power system having a fuel reformer and an internal combustion under the control of a common controller;

FIG. 2 is a simplified block diagram of a power system in which the reformate gas produced by the fuel reformer is supplied to the intake of an internal combustion engine; and

FIG. 3 is a simplified block diagram similar to FIG. 2, but showing a power system in which the reformate gas produced by the fuel reformer is supplied to an emissions abatement device.

### DETAILED DESCRIPTION OF ILLUSTRATIVE EMBODIMENTS

While the concepts of the present disclosure are susceptible to various modifications and alternative forms, specific exemplary embodiments thereof have been shown by way of example in the drawings and will herein be described in detail. It should be understood, however, that there is no intent to limit the disclosure to the particular forms disclosed, but on the contrary, the intention is to cover all modifications, equivalents, and alternatives following within the spirit and scope of the invention as defined by the appended claims.

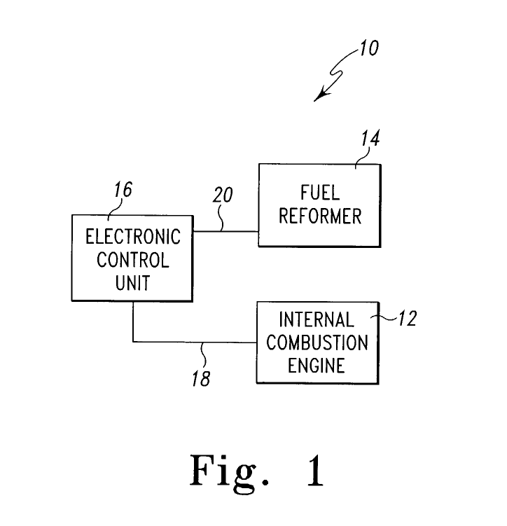

Referring now to FIG. 1, there is shown a power system 10 having an internal combustion engine 12 and fuel reformer 14. The internal combustion engine 12 may be embodied as any type of internal combustion engine including, for example, a spark-ignited gasoline engine, a diesel engine, a natural gas engine, or the like. In such a way, the internal combustion engine 12 produces mechanical output which is utilized to drive or otherwise mechanically power a driven mechanism (not shown) such as a transmission, specifically a vehicle transmission, which is utilized to propel a vehicle or a power generator or the like for producing electrical power.

The fuel reformer 14 reforms (i.e., converts) hydrocarbon fuels into a reformate gas that includes, amongst other things, hydrogen gas. The fuel reformer 14 may be embodied as any type of a fuel reformer such as, for example, a catalytic fuel reformer, a thermal fuel reformer, a steam fuel reformer, or any other type of partial oxidation fuel reformer. The fuel reformer 14 may also be embodied as a plasma fuel reformer (known generally as a “plasmatron”). A plasma fuel reformer uses plasma to convert hydrocarbon fuel into a reformate gas which is rich in, amongst other things, hydrogen gas and carbon monoxide. Systems including plasma fuel reformers are disclosed in U.S. Pat. No. 5,425,332 issued to Rabinovich et al.; U.S. Pat. No. 5,437,250 issued to Rabinovich et al.; U.S. Pat. No. 5,409,784 issued to Bromberg et al.; and U.S. Pat. No. 5,887,554 issued to Cohn, et al., the disclosures of each of which is hereby incorporated by reference.

Both the engine 12 and the fuel reformer 14 are under the control of a common controller. In particular, the internal combustion engine 12 is electrically coupled to an electronic control unit 16 via a signal line 18, whereas the fuel reformer 14 is electrically coupled to the electronic control unit 16 via a signal line 20. In such a way, the electronic control unit 16 may be programmed or otherwise configured to control the operation of both the engine 12 and the fuel reformer 14. Such a feature eliminates the need to provide separate controllers for the engine 12 and the fuel reformer 14 thereby lowering costs and complexity associated with the design of the power system 10.

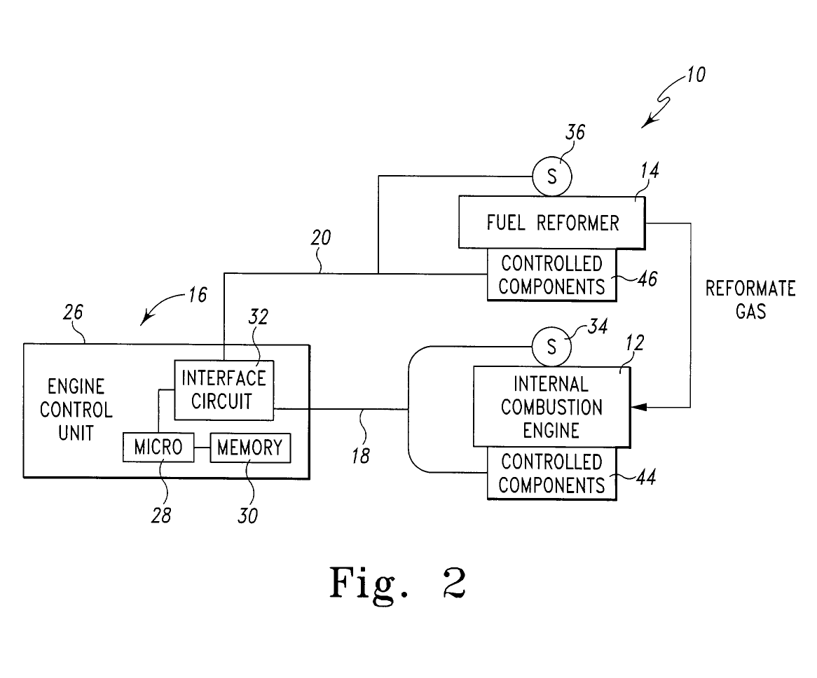

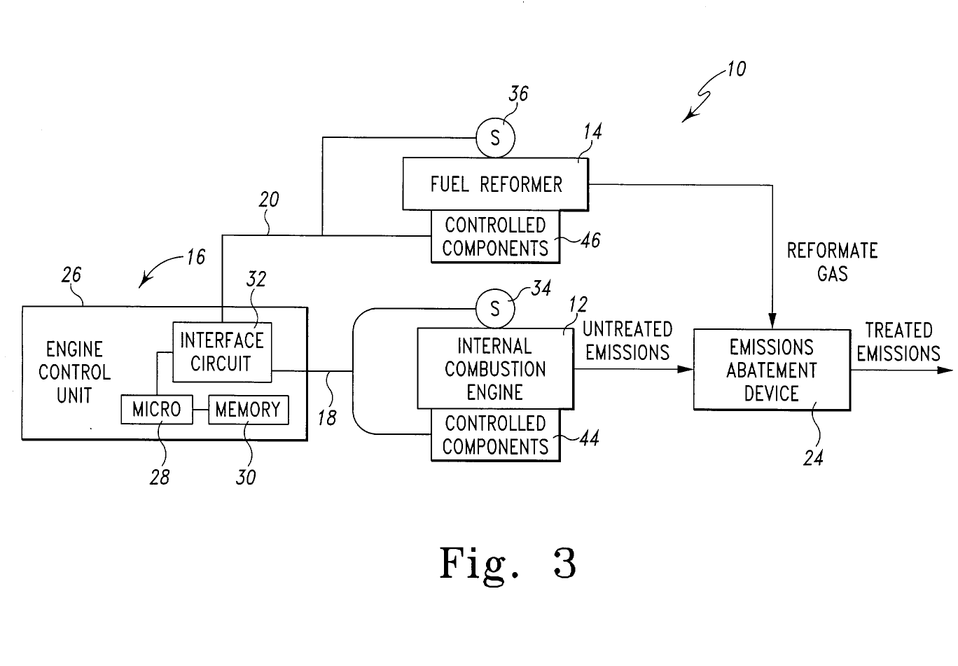

Referring now to FIGS. 2 and 3, there are shown specific exemplary implementations of the power system 10. In the embodiment shown in FIG. 2, the output from the fuel reformer 14 (i.e., reformate gas) is supplied to the intake of the engine 12, whereas in the embodiment shown in FIG. 3, the output from the fuel reformer 14 (i.e., reformate gas) is supplied to an emission abatement device 24 such as a NOx absorber or a soot filter.

Moreover, in the embodiments shown in FIGS. 2 and 3, the electronic control unit 16 is embodied as an engine control unit 26. In particular, engine systems, such as vehicle systems or systems for use in the design of a stationary power generator, include an engine control unit which is, in essence, the master computer responsible for interpreting electrical signals sent by engine sensors and for activating electronically-controlled engine components to control the engine. For example, an engine control unit is operable to, amongst many other things, determine the beginning and end of each injection cycle of each engine cylinder, or determine both fuel metering and injection timing in response to sensed parameters such as engine crankshaft position and rpm, engine coolant and intake air temperature, and absolute intake air boost pressure.

As will herein be described in greater detail, in addition to controlling operation of the engine 12, the engine control unit 26 of the present disclosure also controls operation of the fuel reformer 14. In such a way, the engine control unit 26 is also, in essence, the master computer responsible for interpreting electrical signals sent by sensors associated with the fuel reformer (or engine) and for activating electronically-controlled components associated with the fuel reformer in order to control the fuel reformer. For example, the engine control unit 26 of the present disclosure is operable to, amongst many other things, determine the beginning and end of each injection cycle of fuel into the fuel reformer, determine the amount and ratio of fuel and air to be introduced into the fuel reformer, determine the power level to supply to the fuel reformer in response to sensed parameters such as chemical composition of the reformate gas being produced by the fuel reformer, engine rpm, temperature of the fuel reformer or gas exiting therefrom, and oxygen content of the reformate gas.

To do so, the engine control unit 26 includes a number of electronic components commonly associated with electronic units which are utilized in the control of engine systems. For example, the engine control unit 26 may include, amongst other components customarily included in such devices, a processor such as a microprocessor 28 and a memory device 30 such as a programmable read-only memory device (“PROM”) including erasable PROM's (EPROM's or EEPROM's).

The memory device 30 is provided to store, amongst other things, instructions in the form of, for example, a software routine (or routines) which, when executed by the processing unit, allows the engine control unit 26 to control operation of both the engine 12 and the fuel reformer 14. To do so, as shown in FIGS. 2 and 3, the engine control unit 26 is electrically coupled to both the engine 12 and the fuel reformer 14. In particular, the engine control unit 26 is electrically coupled to the engine 12 via the signal line 18, whereas the engine control unit 26 is electrically coupled to the fuel reformer 14 via the signal line 20. Although each is shown schematically as a single line, it should be appreciated that the signal lines 18, 20 may be configured as any type of signal carrying assembly which allows for the transmission of electrical signals in either one or both directions between the engine control unit 26 and the engine 12 or the fuel reformer 14, respectively. For example, either one or both of the signal lines 18, 20 may be embodied as a wiring harness having a number of signal lines which transmit electrical signals between the engine control unit 26 and the engine 12 or the fuel reformer 14, respectively. In such an arrangement, signals generated by operation of a number of engine sensors 34 or fuel reformer sensors 36 are transmitted to the engine control unit 26 via the corresponding wiring harness, and signals generated by the engine control unit 26 are transmitted to the engine 12 or the fuel reformer 14 by the corresponding wiring harness. It should be appreciated that any number of other wiring configurations may be used. For example, individual signal wires may be used, or a system utilizing a signal multiplexer may be used for the design of either one or both of the signal lines 18, 20. Moreover, the signal lines 18, 20 may be integrated such that a single harness or system is utilized to electrically couple both the engine 12 and the fuel reformer 14 to the engine control unit 26.

The engine control unit 26 also includes an analog interface circuit 32. The analog interface circuit 32 converts the output signals from the various analog engine sensors 34 and fuel reformer sensors 36 into a signal which is suitable for presentation to an input of the microprocessor 28. In particular, the analog interface circuit 32, by use of an analog-to-digital (A/D) converter (not shown) or the like, converts the analog signals generated by the sensors 34, 36 into a digital signal for use by the microprocessor 28. It should be appreciated that the A/D converter may be embodied as a discrete device or number of devices, or may be integrated into the microprocessor 28. It should also be appreciated that if any one or more of the sensors 34, 36 generate a digital output signal, the analog interface circuit 32 may be bypassed.

Similarly, the analog interface circuit 32 converts signals from the microprocessor 28 into an output signal which is suitable for presentation to the electrically-controlled components 44 associated with the engine 12 and the electronically-controlled components 46 associated with the fuel reformer 14. In particular, the analog interface circuit 32, by use of a digital-to-analog (D/A) converter (not shown) or the like, converts the digital signals generated by the microprocessor 28 into analog signals for use by the electronically-controlled components 44 associated with the engine such as the fuel injector assembly, ignition assembly, fan assembly, etcetera, along with analog signals for use by electronically-controlled components 46 associated with the fuel reformer 14 such as, depending on the type and/or design of the fuel reformer, the air and/or fuel metering valves, fuel injector, plasma head, etcetera. It should be appreciated that, similar to the A/D converter described above, the D/A converter may be embodied as a discrete device or number of devices, or may be integrated into the microprocessor 28. It should also be appreciated that if any one or more of the electronically-controlled components 44 associated with the engine 12 or electronically-controlled components 46 associated with the fuel reformer 14 operate on a digital input signal, the analog interface circuit 32 may be bypassed.

Hence, the engine control unit 26 may be operated to control operation of both the engine 12 and the fuel reformer 14. In particular, the engine control unit 26 operates in a closed-loop control scheme in which the engine control unit 26 monitors outputs of the sensors 34, 36 in order to control the inputs to the controlled components 44, 46 thereby managing the operation of both the engine 12 and the fuel reformer 14. In particular, the electronic control unit 26 communicates with the sensors 34 in order to determine, amongst numerous other things, the engine coolant temperature, manifold air pressure, crankshaft/flywheel position and speed, and the amount of oxygen in the exhaust gas. Armed with this data, the electronic control unit 26 performs numerous calculations each second, including looking up values in preprogrammed tables, in order to execute routines to perform such functions as varying spark timing or determining how long the fuel injector is to be left open in a particular cylinder.

Contemporaneous with such control of the engine 12, the engine control unit 26 also executes a routine for controlling operation of the fuel reformer 14. In particular, the electronic control unit 26 communicates with the sensors 36 in order to determine, amongst numerous other things, the amount of air or fuel being supplied to the fuel reformer, the amount of oxygen in the reformate gas, the temperature of the fuel reformer or the reformate gas, and the composition of the reformate gas. Armed with this data, the electronic control unit 26 performs numerous calculations each second, including looking up values in preprogrammed tables, in order to execute algorithms to perform such functions as determining when or how long the fuel reformer's fuel injector or other fuel input device is opened, controlling the power level input to the fuel reformer, controlling the amount of air advanced through an inlet air valve of the fuel reformer, etcetera.

In operation, the engine control unit 26 controls operation of both the engine 12 and the fuel reformer 14. In particular, during operation of the engine 12, the engine control unit 26 executes a fuel injector control routine which, amongst other things, generates a number of injection signals in the form of injection pulses which are communicated to the individual injectors of the engine's fuel injector assembly. In response to receipt of the injection pulse, a fuel injector is opened for a predetermined period of time, thereby injecting fuel into the corresponding cylinder of the engine 12. Contemporaneous with execution of the engine control routine, the engine control unit 26 executes a fuel reformer control routine which, amongst other things, generates a number of control signals which are communicated to the various electronically-controlled components 46 associated with the fuel reformer 14, thereby controlling operation of the reformer 14. For example, signals are generated and communicated for, amongst other things, varying the amount of air being supplied to the fuel reformer through the reformer's air inlet valve, varying the power supplied to the plasma fuel reformer, or operating the fuel injector so as to inject fuel, or a certain amount of fuel, into the fuel reformer.

Moreover, the engine control unit 26 also monitors input from the various sensors 36 associated with the reformer 14 in order to utilize such input in the closed-loop control of the reformer 14. For example, signals communicated to the engine control unit 26 are utilized to monitor chemical composition of a reformate gas produced by the fuel reformer, the temperature of the reformer or the reformate gas exiting therefrom, or the oxygen content of the reformate gas.

It should be appreciated that such routines (i.e., the fuel injector control routine and the fuel reformer control routine) may be embodied as separate software routines, or may be combined as a single software routine.

As can be seen from the foregoing description, the concepts of the present disclosure provide numerous advantages and benefits relative to other systems. For example, amongst other things, the concepts of the present disclosure allow for the control of both an internal combustion engine and a fuel reformer with the same electronic control unit (e.g., the engine control unit 26). As a result, the costs and complexity of the power system is reduced relative to systems requiring separate control units.

While the concepts of the present disclosure have been illustrated and described in detail in the drawings and foregoing description, such an illustration and description is to be considered as exemplary and not restrictive in character, it being understood that only the illustrative embodiments have been shown and described and that all changes and modifications that come within the spirit of the disclosure are desired to be protected.

There are a plurality of advantages of the concepts of the present disclosure arising from the various features of the systems described herein. It will be noted that alternative embodiments of each of the systems of the present disclosure may not include all of the features described yet still benefit from at least some of the advantages of such features. Those of ordinary skill in the art may readily devise their own implementations of a system that incorporate one or more of the features of the present disclosure and fall within the spirit and scope of the invention as defined by the appended claims.

1. A method of operating a power system having an internal combustion engine and a fuel reformer, the method comprising the steps of:
generating an injector signal with an engine control unit,
injecting fuel into a cylinder of the internal combustion engine in response to generation of the injector signal,
generating a reformer signal with the engine control unit, and
operating the fuel reformer based on the reformer signal.

2. The method of claim 1, wherein:
the fuel reformer comprises a plasma fuel reformer, and
the operating step comprises varying the power supplied to the plasma fuel reformer based on the reformer signal.

3. The method of claim 1, wherein:
the fuel reformer has a fuel injector, and
the operating step comprises operating the fuel injector so as to inject fuel into the fuel reformer based on the reformer signal.

4. The method of claim 1, wherein:
the fuel reformer has a fuel injector, and
the operating step comprises varying the amount of fuel injected into the fuel reformer by the fuel injector based on the reformer signal.

5. The method of claim 1, wherein:
the fuel reformer has an air inlet valve, and
the operating step comprises varying the amount of air being supplied to the fuel reformer through the air inlet valve based on the reformer signal.

6. The method of claim 1, further comprising the steps of:
sensing chemical composition of a reformate gas produced by the fuel reformer and generating a composition signal in response thereto, and
communicating the composition signal to the engine control unit.

7. The method of claim 6, wherein the reformer signal generating step comprises generating the reformer signal based on the composition signal.

8. An engine control unit, comprising:
a processor, and
a memory device electrically coupled to the processor, the memory device having stored therein a plurality of instructions which, when executed by the processor, causes the processor to:
(a) execute a fuel injector control routine for controlling operation of a fuel injector assembly of an internal combustion engine, and
(b) execute a fuel reformer control routing for controlling operation of a fuel reformer.

9. The engine control unit of claim 8, wherein the plurality of instructions, when executed by the processor, further causes the processor to execute the fuel reformer control routine so as to control the power supplied to the fuel reformer.

10. The engine control unit of claim 8, wherein the plurality of instructions, when executed by the processor, further causes the processor to execute the fuel reformer control routine so as to control operation of a fuel injector associated with the fuel reformer.

11. The engine control unit of claim 8, wherein the plurality of instructions, when executed by the processor, further causes the processor to execute the fuel reformer control routine so as to varying the amount of fuel injected into the fuel reformer by a fuel injector.

12. The engine control unit of claim 8, wherein the plurality of instructions, when executed by the processor, further causes the processor to execute the fuel reformer control routine so as to control the amount of air supplied to the fuel reformer.

13. The engine control unit of claim 8, wherein the plurality of instructions, when executed by the processor, further causes the processor to execute the fuel reformer control routine so as to monitor the chemical composition of a reformate gas produced by the fuel reformer.

14. A power system, comprising:
an internal combustion engine having an electronically-controlled fuel injector assembly,
a fuel reformer, and
an engine control unit, the engine control unit being electrically coupled to both the fuel injector assembly and the fuel reformer.

15. The power system of claim 14, wherein the engine control unit is configured to control operation of both the fuel injector assembly and the fuel reformer.

16. The power system of claim 14, wherein the engine control unit is electrically coupled to a sensor for sensing chemical composition of a reformate gas produced by the fuel reformer.

17. The power system of claim 14, wherein:
the fuel reformer comprises a fuel injector, and
the engine control unit is electrically coupled to the fuel injector of the fuel reformer.

18. The power system of claim 14, wherein:
the fuel reformer comprises an air inlet valve, and
the engine control unit is electrically coupled to the air inlet valve.

19. The power system of claim 14 wherein the fuel reformer comprises a plasma fuel reformer.
